(19) United States
(12) Patent Application Publication
(10) Pub. No.: US 2024/0068860 A1
(43) Pub. Date: Feb. 29, 2024

(54) SILO FILL LEVEL SENSOR AND METHOD

(71) Applicant: Virtual EM Inc., Ann Arbor, MI (US)

(72) Inventors: Tayfun Ozdemir, Ann Arbor, MI (US); Kevin Bi, Ann Arbor, MI (US)

(73) Assignee: Virtual EM Inc., Ann Arbor, MI (US)

(21) Appl. No.: 17/893,602

(22) Filed: Aug. 23, 2022

(51) Int. Cl. G01F 23/296

(52) U.S. Cl. CPC G01F 23/2968

(57) ABSTRACT

A fill level sensor monitors the level of material, such as grain, in a storage silo. A controller includes a logic circuit, a solenoid assembly including an electromagnet fixedly attached to an external wall of the silo and a plunger which is displaceable in response to electrical energization of the electromagnet between a first position spaced from the silo wall and a second position contacting the silo wall to affect an impact noise. A microphone detects each time the plunger contacts the wall. A memory records each plunger strike, and the time between successive plunger strikes. The controller and microphone are affixed to an outer wall of the silo by permanent magnets. A warning signal alerts when a fill level drops below a pre-determined level or reports in real time the estimate of the fill level in terms of percentages or actual height from the bottom of the silo.

### TECHNICAL FIELD

The present invention is related to agricultural type storage bins and/or silos configured for receiving, storing and dispensing particulate matter such as granulated grains and other food stuffs, and more particularly to apparatus and methods for noninvasively detecting the real time level of material disposed within such storage bins.

### BACKGROUND OF THE INVENTION

Continuously accurately monitoring the fill level of a farm feed silo is important to farmers, enabling them to timely schedule a refill when the fill level is at a minimum safe level, but not at risk of running out completely and causing an operating stoppage at the farm. Some farmers simply use their experience and base timing of refills upon past experience. Typical methods of determining the fill level include climbing an attached ladder to hit the side of the silo with an object/first to hear the echo or having to look inside the silo from a hatch on top of the silo, which is prone to errors due to losing distance perspective.

In winter conditions, the ladder can be slippery and there are numerous slip and fall type accidents on record including falling inside of the silo, and thus unnecessary inspections are to be avoided. Also, such measurements are subject to interpretation and are often inaccurate.

Certain electronic level sensors are known which are mechanically attached to the side of the silo and include a probe extending through an opening which can result in leaks and cannot easily be relocated based on changing weather conditions and different silo content. Known sensor(s) typically are attached to the external surface of the silo. Such conventional sensors typically employ radar-based signal generators which deflect signals and measure the time for receiving a return signal to ascertain how full it is.

Fill level gauges are used in general to measure the fill level of a product in a container or of bulk material on a bulk material pile. Radar-based fill level gauges emit radar signals in the direction of the surface of the product or of the bulk material, wherein a portion of the radar signal is reflected off the surface and can be received by the fill level gauge. The time-of-flight of the radar signal from the radar sensor to the surface and back is proportional to the length of the distance traveled, so that the fill level can be determined based upon the time of flight. Radar-based point level gauges, in general, involve ascertaining when a certain fill level and/or point level of the medium present in the container is reached.

So as to emit and/or receive the radar signal, the fill level and/or point level gauges generally comprise an antenna. The fill level and/or point level gauges are frequently provided on the containers in such a way that the antenna protrudes into the interior of the container. This regularly requires complex fixation of the radar sensor on the container and appropriate sealing of the fixation point. Laser-based systems are also used based on time-of-flight measurements, but such systems again have to be installed inside of the container (typically inside of the top surface) and often produce erroneous results due to the dust inside the container reflecting the light. In addition, all time-of-flight based sensors often produce erroneous results because the silo content does not always drop with a flat surface, but rather forms an irregular conical shape with the feed adhering to the side walls. Therefore, volume-based sensing is more accurate because the volume is what the silo owners like to know.

A search of issued U.S. patents and patent applications in the field of radar-based fill level sensors for storage bins and related apparatus reveals U.S. patents related generally to the field of the present invention but which do not anticipate nor disclose the device of the present invention. A discovered U.S. patent application, an issued U.S. patent and a published technical article relating generally to the present invention are discussed herein below.

U.S. Patent Application Publication Number US 2020/0041324 A1 to Dieterle entitled “Radar Sensor for Fill Level or Point Level Measurement” discloses a radar sensor for measuring a fill level and/or a point level of a product in a container. The radar sensor includes a sensor configured to emit and/or receive a radar signal, evaluation circuitry configured to determine a measurement signal, a housing having at least one housing region configured such that the radar signal can be transmitted through the housing region, an adhesive surface including an adhesive material configured to attach the radar sensor to the container wall, is disposed on the outside of the housing at least along a portion of an outer circumference of the housing region.

U.S. Pat. No. 8,434,27881 to Dueck et al. entitled “Storage Bin Support System” discloses a storage bin support system providing a leg structure to support the storage bin in a fixed, upright orientation, and allow easier access underneath. The storage bin support system generally includes a bin for holding the particulate material, wherein the bin includes a roof, sidewalls, and a base, and wherein the roof includes an inlet for filling the bin, and wherein the base includes an outlet for emptying the bin, and a supporting framework for supporting the bin above a ground surface in an upright position, wherein the supporting framework includes an outer framework and an inner framework interconnecting the outer framework with the base. The outer framework is spaced along an outer perimeter of the bin and the inner framework includes a plurality of upper angled supports comprising an upper end and optionally a plurality of lower angled supports comprising a lower end.

Garcia, Adrian et al., Non-Intrusive Tank-Filling Sensor Based on Sound Resonance, Electronics, 2018, 7, 378; doi:10.3390/electronics 7120378. Abstract: Different types of fill-level measurement systems exist in the market, but most of them imply some type of intrusion in the tank itself. In this paper, a reconfigurable system based on sound resonance for measuring the fill-level of a tank from the exterior is presented. A relation between sound resonance frequencies and the content of the tank has been found, especially as the tank gets closer to being full. A prototype has been created using reconfigurable technologies combined with wireless communications in order to control the system from an ad hoc application, especially when the tank is over half of its capacity. The difference between this method and the present invention is that this method utilizes the resonance frequencies present in the echo generated inside the container while the present invention utilizes the power of the echo. While resonance frequencies are strongly dependent on the silo dimensions and shape, the fashion in which the present invention utilizes the power of the echo make it lightly dependent on the silo dimensions and shape and hence requires much less calibration. Further, this method makes the assumption that the strongest spectral component is associated with the level of the content, and therefore is only applicable to liquid-filled metallic containers where the content always has a flat level, and hence would produce erroneous results for solid content, whose level is irregular and never flat. Further, the strongest spectral component is not always a determinant of the liquid level but could rather be determined by the dimensions of the container if it is metal with flat top and bottom. The authors of the present invention studied the spectral method in detail initially and found it to be unreliable for both liquid and solid content. In contrast, the authors found that the echo power utilized in the present invention strongly correlates with the volume of the content and hence would work well for both liquid and solid content including both metallic and non-metallic containers.

Application US 2020/0041324 A1, U.S. Pat. No. 8,434,278 and Electronics article are hereby incorporated herein by reference.

### SUMMARY OF THE INVENTION

The forgoing problems and limitations are overcome and other advantages are provided by new and improved non-intrusive silo fill-leveling sensors based upon sound echo power.

Therefore, it is an object of the present invention to provide an acoustic sensor which records echoes generated by a solenoid plunger strike on an external storage silo surface and determines the silo fill level based upon a calibrated algorithm which calculates the total power of the echo and adapts to a given silo as a function of the rise and fall of the calculated echo strength through a plurality of initial silo refill cycles. Because of its design, the present invention is non-intrusive and attaches via magnets to metallic silos or via metallic patches, Velcro pads or adhesives/glue to non-metallic containers.

The present invention provides circuit elements including a microcontroller, an SD card, a reset button, a read-out device, and a power supply which are compact and integrated with the sensor, which is attached to the storage silo system via magnets.

According to one aspect of the invention, at least one hermetically sealed housing encloses the circuit elements providing a robust weather-proof design,

According to another aspect of the invention, one or more permanent magnets are employed to affix the housing to a predetermined external position on said external silo surface, and can be re-located as part of a calibration process.

According to yet another aspect of the invention, a microphone in-circuit with the electrical network and hermetically sealed within the housing or, alternatively, within a second housing which is firmly magnetically affixed to the exterior surface of the silo at a location adjacent or, alternatively, spaced from the first housing, thus making the overall system extremely efficient and easily reconfigurable.

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1, is a side plan view of a typical large farm storage silo for particulate matter to which a system of three vertically spaced level sensors embodying the present invention is applied;

FIG. 2, is a bottom plan view of the storage silo of FIG. 1;

FIG. 3, is a cross-sectional view taken along lines 3-3 through the bin portion of the silo of FIG. 1 with the bottom automated discharge gate illustrated in phantom;

FIG. 4, is a perspective view of one of the three silo fill level sensors of FIG. 1 illustrating the interior of a hermetically sealed housing adapted for magnetic attachment to the outer surface of a ferrous silo wall, the housing enclosing a solenoid assembly, a control electronics package, and an illuminated on/off reset pushbutton switch, as well as a separate sensor power adapter electrically interconnecting the sensor with a remote power source, and a remote hermetically sealed microphone housing enclosing a microphone assembly electrically interconnected with the sensor and which is also magnetically attached to the outer surface of the ferrous silo wall;

FIG. 5, is an alternate perspective view of the representative fill level sensor of FIG. 4 illustrating the housing mechanically supporting a plurality of permanent mounting magnets encircling a solenoid plunger extending outwardly through an opening in the housing, an illuminated on/off push button reset switch and the electrical feed line to a remote microphone enclosure, and said plurality of permanent magnets are mounted to an associated fill level sensor to form a surface to surface alignment with an adjacent portion of the outer surface of an associated storage bin wall for maximum, engagement therebetween;

FIG. 6, is a plan view of the remote microphone enclosure for the fill sensor of FIGS. 4 and 5, illustrating a pair of spaced mounting magnets, a surface mount microphone, and an electric cable interconnecting the microphone enclosure with the representative fill level sensor of FIGS. 4 and 5 in a spaced-apart relationship;

FIG. 7, is a schematic block view of circuit elements of the representative fill level sensor of FIGS. 4 and 5 illustrating its juxtaposition with a silo such as illustrated in FIG. 1. Each fill level sensor is substantially identical, including a microcontroller which performs the logic processing. The solenoid, the microphone, the control button/switch, the LED/readout display and the memory/SD card are all interconnected to the microcontroller. The solenoid and microphone are illustrated in juxtaposition with a silo for transmitting echo waves therethrough. A local power supply separately serves each fill level sensor. Finally, a remote power source serves the entire system through a common control panel via an electrical conduit;

FIG. 8, is a graphical depiction of typical ambient noise and echoes recorded by a single sensor's microphone over a large number of test samples, whereby a sensor control algorithm first denoises the echo, then computes the power of the echo and then uses that value to determine if the silo is near empty and has to be refilled. The denoising of the echo is accomplished by computing the frequency content in the areas labeled “noise” and “echo”, and then subtracting the noise spectra from the echo, and then integrating the denoised echo over time to obtain an estimate of the echo power or “loudness”;

FIG. 9, is a graphical depiction of echo power vs. time showing emptying and filling of the single-level sensor system of the silo of FIG. 13, showing a large number (approx. 1400) computed echo powers plotted against time with each data point representing how loud the echo is after each solenoid hit. This particular data was collected by a solenoid hit repeated five times one second apart every 30 minutes, and wherein for each data point shown in the figure, the echo powers of successive hits (one second apart) are averaged to eliminate occasional slips in solenoid hits. Comparing against actual silo fill levels shows that the increases in echo power correlate well with level drop (the echo gets louder as the silo empties);

FIG. 10, is a graphical depiction of echo power vs. fill-level based on ground-truth data demonstrating how echo power continuously increases with declining fill level and is generated using the data in FIG. 9. The relationship between echo power and the fill level is non-linear as depicted. Nevertheless, it is possible to invert this curve to estimate the fill level in percentage using the data in FIG. 9. Alternatively, it is also possible to use this curve to set a threshold as depicted in FIG. 9 to trigger an alert that the fill level is low and it is time to order the grain truck to come and fill the silo. Exactly where the threshold is set completely depends on when the farmer wants to be notified. Small silos or large silos where the diameter and height are comparable are more suited for this operation and can be managed using a single sensor. FIG. 9 shows three cycles, but all three cycles follow a similar pattern and, therefore, the curve in FIG. 10 can be generated using a single cycle and the sensor can start reporting fill levels or give alerts following a single refill cycle;

FIG. 11, is a graphical depiction of echo power readings vs. time recorded collectively by each of the three vertically spaced sensors installed on a tall silo similar to that depicted in FIG. 1 through an entire empty—fill—empty—fill—cycle. In large silos or in silos where the height is at least 1.5 times the diameter (such as the one depicted in FIG. 1), a single sensor solution will not provide sufficient accuracy because the echo power will exhibit strong local behavior, i.e., the echo power measured by a sensor placed high up on the silo will exhibit vastly different behavior than one placed close to the bottom of the silo. This is clearly evident in FIG. 11, which shows the time variance of echo power measured by three sensors placed at different heights along a tall silo with a height-to-diameter ratio of 4. Consequently, the use of a single sensor in this case would not render a very accurate calibration curve such as the one shown in FIG. 10. In such silos, multiple sensors are therefore required to accurately track change in the fill level. The moments when the fill level crosses the sensor locations are clearly identifiable with a low-to-high transition of the echo power. Naturally, this transition happens first at the sensor close to the top, then at the mid-point sensor, and finally the sensor at the bottom. Also clearly identifiable is the moment the silo is refilled marked by an abrupt drop in echo power in all sensors simultaneously, which comes right after the level crosses the sensor location at the bottom, which makes sense. There are multiple ways to utilize the data in FIG. 11 to generate actionable information about the fill-level. For one, each sensor can report the location crossings, i.e., at a minimum, one would know if the level is above the top sensor, or in between the top and mid-level sensors, or between the mid-level and the bottom sensors, or below the bottom sensor. This alone is very usable information for the owner of the silo. Alternatively, the fill level drop speed can be estimated using the sensor crossing times and the location of the sensors, which can be uses during the next cycle to estimate and track the fill level with high accuracy in real time assuming the level drop speed does not vary appreciably over multiple cycles. There is one scenario, of course, where a single sensor would also work in tall silos. If the silo owner is only interested in knowing when the fill level crosses a particular height, then all one has to do is place a sensor at that location and report the sensor crossing using the data shown in FIG. 11;

FIG. 12, is a cross-sectional schematic view of a typical single sensor storage silo which is approximately ⅔ full of bulk material depicting signal waves emitted by the sensor and the reflected waves (echo) delimited by the presence of the bulk material in the silo;

FIG. 13, is a single sensor system installed on a relatively small silo employed for field testing, wherein the sensor includes a solenoid, a microprocessor, an SD card, an LED, a power supply and a microphone; and

FIG. 14, is a cross-sectional view of striker assembly of a silo fill level sensor in broken view on an enlarged scale.

### DESCRIPTION OF THE PREFERRED EMBODIMENTS

The preferred embodiments of the present invention disclosed herein comprise a non-intrusive fill level sensor based upon sound echo power.

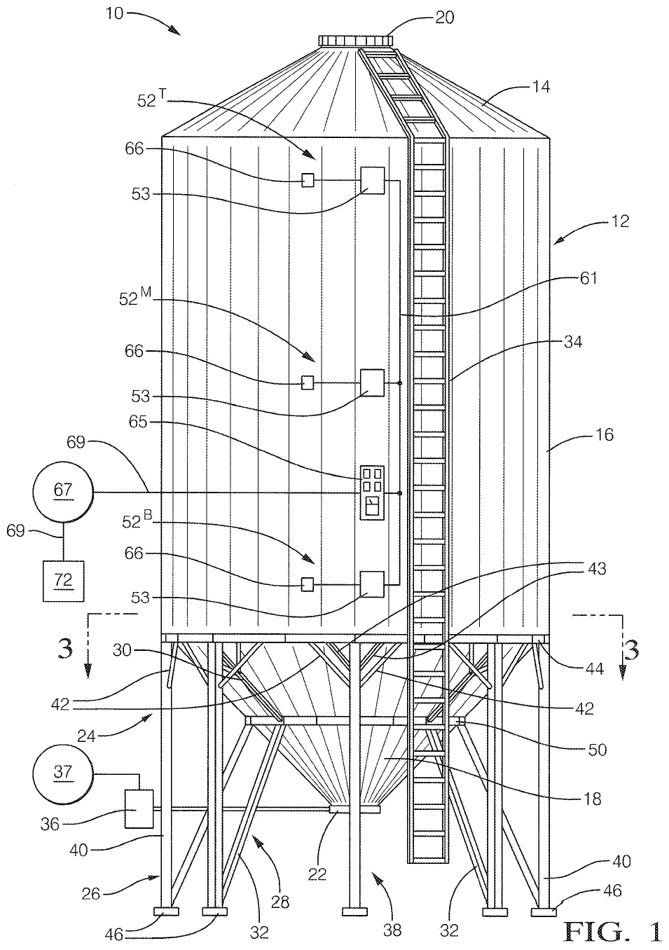

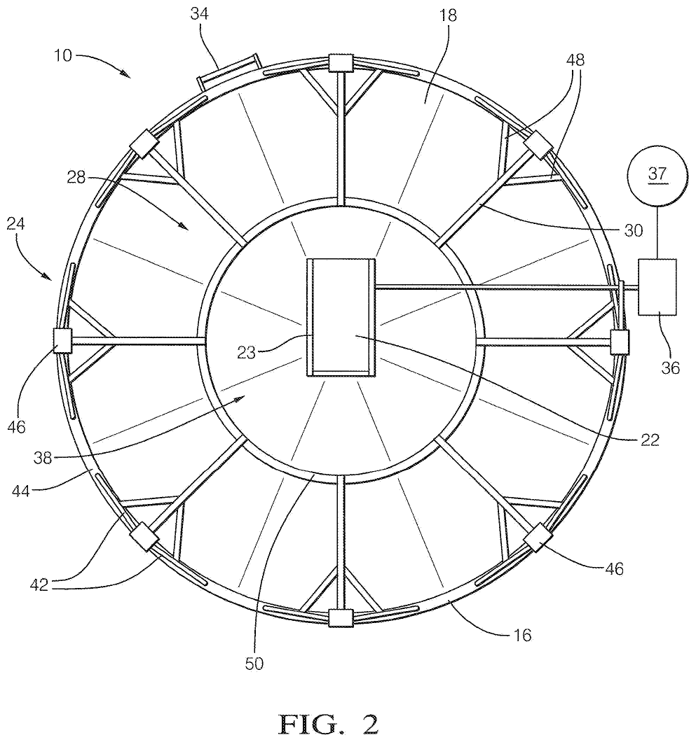

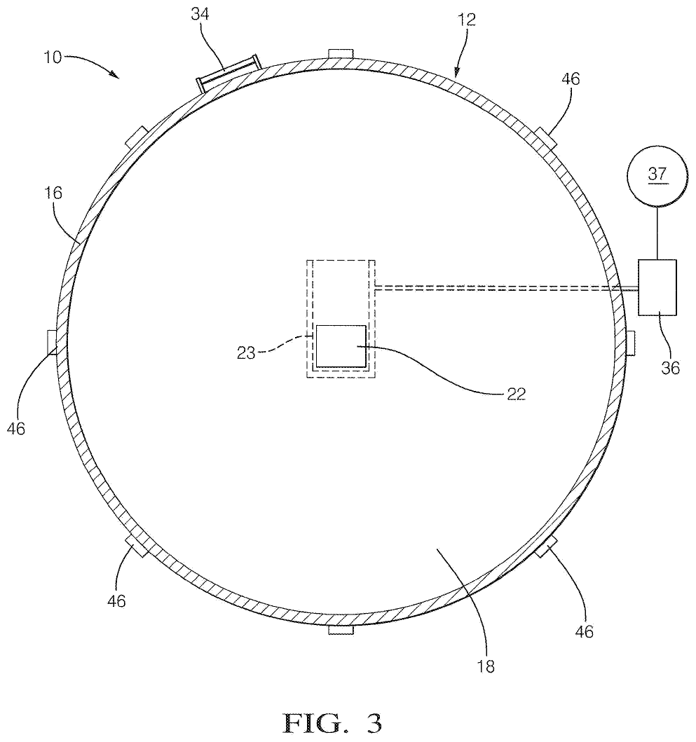

Turning now descriptively to the drawings, in which similar reference characters denote similar elements throughout the several views, FIGS. 1 through 3 illustrate a storage bin support system 10, which comprises a relatively large bin/silo 12 for holding/storing particulate matter, wherein the bin 12 includes a cover/roof 14, sidewalls 16, and a base 18. The roof 14 includes an inlet 20 for filling the bin 12 and the base 18 includes an outlet 22 for emptying the bin 18, preferably by gravity discharge into a suitable vehicle or transport mechanism. A supporting framework 24 supports the bin 12 above a ground surface in an upright position and includes an outer framework 26 and an inner framework 28 interconnecting the outer framework 26 with the base 18. The outer framework 26 is spaced along an outer perimeter of the bin 12 and the inner framework 28 includes a plurality of upper angled supports/braces 30, each comprising an upper end and a plurality of lower angled supports 32 comprising a lower end. In an alternative embodiment, the upper angled supports/braces 30 and lower angled braces 32 are not required and are thus omitted.

The storage bin 12 is typically used for storing a particulate material, such as various types of grain, seed, crop or other material. However, the storage bin 12 may be used to store various types of particulate materials, or other types of materials rather than those described. The storage bin 12 is generally of a large structure for holding bulk amounts of a particulate material. The storage bin 12 is also generally comprised of a self-supporting structure and is supported in an upright position so as to fill the storage bin 12 from the upper end and to empty the storage bin 12 from a lower end. The storage bin 12 may be comprised of various rigid materials, preferably such as ferrous metal.

In the preferred embodiment of the invention, the storage bin 12 includes a roof 14 defining a generally conical shape for precise filling through the inlet 20, a cylindrical shaped sidewall 16, and a base 18 opposite the roof 14 which also defines an inverted conical shape for more precise emptying through an outlet 22. The bin 12 is comprised of a substantially hollow structure and may include various internal supporting members (not illustrated) to maintain its nominal shape.

The roof 14 also generally includes an inlet 20 which is centrally located at an uppermost end for filling the storage bin 12. The inlet 20, as appreciated, may include various types of cover or closure means which selectively provides access to the interior of the bin 12 and selectively hermetically seals the bin 12 to prevent entry of contaminating elements and moisture. A ladder 34, or other accessing means may be located along the external side of the storage bin 12 for accessing the inlet 20 to enable maneuvering a dumping or filling mechanism and to open or close the cover over the inlet 20.

The base 18 includes an outlet 22, which is also preferably centrally located at the lowermost end for emptying the storage bin 12. Generally, when emptying the storage bin 12, an auger end (not illustrated) is extended below the outlet 22 of the base 18 and the particulate material is simply released through the outlet gate 23 onto the auger to be transferred to another location. The outlet 22 may include various types of gate assemblies 36, such as a mechanized drive 36 energized by an external AC power source 37 or, alternatively, by a mechanical hand crank mechanism, automatic gate, or various others to open and/or close the outlet 22. Any AC power source (such as 37 and 67) is spaced and electrically insulated from the storage bin 12 and support system for safety purposes. The base 18 may also include side openings as appreciated for faster emptying of the bin 12 or emptying in a different location or rate.

Because of the manner in emptying the storage bin 12 through the bottom of the base 18, the base 18 and storage bin 12 are preferably supported above a ground surface and a sufficient access space 38 is located thereunder for inspection purposes, as well as positioning an auger. The storage bin 12 is supported above the ground surface via a supporting framework 24 which will be described subsequently.

The supporting framework 24 is used to support the bin 12 above the ground surface in an upright position. The supporting framework 24 is also spaced apart to allow various entrances to the below access space 38 for positioning the auger or other transferring mechanism, and also to allow for inspection and maintenance of the bottom components of the storage bin 12. Unless otherwise noted, the supporting framework 24 is generally comprised of a substantially strong and rigid material, such as metal.

The supporting framework 24 generally includes the outer framework 26 which is positioned along an outer perimeter of the sidewall 16 and an inner framework 28, which is connected to the outer framework 26 and is generally positioned under the base 18 for providing support beneath the storage bin 12. The inner framework 28 thus extends within the access space 38 and is arranged in a manner to take up the least amount of access space 38 while providing optimal support for the base 18 and storage bin 12.

The outer framework 26 is generally comprised of an outer support ring 44 which is positioned at a lower end of the sidewalls 16 along an intersection of the sidewalls 16 and the base 18. Extending vertically below the support ring 44 are a plurality of legs 40. The legs 40 are preferably vertically oriented and are circumferentially spaced apart along the perimeter of the supporting ring 44 and outer perimeter of the storage bin 12. The legs 40 are adequately spaced apart to allow multiple entrances to the access space 38 beneath the base 18 and the storage bin 12.

The legs 40 are comprised of a length longer than the height of the base 18 to secure the base 18 above the ground surface. Each of the legs 40 generally include a plurality of braces 42 extending at an angle from each side of the legs 40 at an upper end. The braces 42 generally connect the upper end of the legs 40 with the outer support ring 44 and form a triangular shape with the outer ring 44 and the legs 40. Each of the legs 40 also generally include a foot member 46 located at the lowermost end of the legs 40 for providing an increased surface area for the lower end of each leg 40 to provide extra stability and to prevent the legs 40 from sinking within the ground surface and destabilizing the overall structure.

The inner framework 28 is positioned completely within the access space 38 beneath the storage bin 12 and inside of the outer framework 26 with respect to the access space 38 being inside of the outer framework 26 and external environment surrounding the storage bin 12 being positioned outside of the outer framework 26. The inner framework 28, being positioned within the access space 38, thus generally takes up the least amount of space as required as long as the inner framework 28 provides adequate support for the base 18 and storage bin 12.

The inner framework 28 generally interconnects the outer framework 26 with the base 18 of the storage bin 12 to provide extra support to the base 18, wherein the base 18 supports all of the particulate matter within the storage bin 12. Additionally, because of the optimal supporting structure of the inner framework 28, the base 18 generally does not need to be as thick as traditional bases 18 of other grain bins 12 or hoppers, thereby reducing cost and weight.

The inner framework 28 generally interconnects the outer framework 26 with the base 18 of the storage bin 12 to provide extra support to the base 18, wherein the base 18 supports all of the particulate material within the storage bin 12. Additionally, because the optional supporting structure of the inner framework 28, the base 18 generally does not need to be as thick as traditional bases 18 of other grain bins 12 or hoppers.

In the preferred embodiment, the inner framework 28 includes a plurality of upper angled supports 30 which extend at an angle along the exterior of the conical shaped base 18 of the outer ring 44 towards the centrally located outlet 22. Each of the upper angled supports 30 are circumferentially spaced from one another along the perimeter of the base 18 and each further preferably aligns with a respective leg 40 of the outer framework 26. Each of the angled supports 30 also preferably includes a pair of angled braces 48 forming a triangular shape with the respective upper angled support 30 and supporting ring 44 of the outer framework 26. The braces 42 and the upper angled supports 30 are each preferably attached to or run along and parallel to the exterior surface of the base 18. Alternatively, in certain applications, the upper angled braces 30 and the lower braces 48 may not be required and can, thus, be omitted.

Each of the upper angled supports 30 extend along the exterior surface of the base 18 to a supporting ring 50 of the inner framework 28. The supporting ring 50 of the inner framework 28 extends around the exterior of the base 18 and is circular in shape. Height wise, the inner supporting ring 50 is preferably positioned at a generally midway point between the outlet 22 along the lowermost point of the base 18 and the lower supporting ring 44 along the uppermost point of the base 18. The positioning of the inner supporting ring 50 substantially above the outlet 22 helps to provide available access space 38 near the outlet 22 for easily accessing the outlet 22. The inner supporting ring 50 thus is comprised of a lesser perimeter than the outer supporting ring 44.

The lower angled supports 32 extend at an angle from the inner supporting ring 50 to the lowermost end of the legs 40 of the outer framework 26. Thus, a portion of the lower angled supports 32 extend below the outlet 22 for connecting with the legs 40. The lower angled supports 32 may be directly connected to the base 18 at an upper end or indirectly connected to the base 18 through the inner supporting ring 50.

Each of the lower angled supports 32 are spaced apart from each other along the perimeter of the base 18 and each preferably aligns with a respective leg 40 of the lower framework 26. Having the lower angled supports 32 extend at an angle rather than horizontal substantially increases the amount of available access space 38 underneath the base 18 for positioning the auger below the outlet 22. The corresponding upper angled supports 30, lower angled supports 32 and legs 40 further each form a triangular shaped connected structure.

Referring to FIG. 1, knowing the fill level of a feed silo 12 is important to the farmers because they have to call a fill truck before the silo 12 empties so there is no stoppage at the farm. Typical methods of determining the fill level include climbing the attached ladder 34 to hit the side of the silo 16 with a first or hammer and climbing to the top of the silo 14 to look inside through the inlet 20. In winter weather, the ladder 34 can be slippery and prone to causing slip-and-fall accidents. Also, such measurements are subject to interpretation and are often inaccurate. Accordingly, the present invention provides one or more fill level sensors 52 (three are illustrated) which are secured to the outer surface of the storage bin 12 via magnets and uses acoustic signals to ascertain how full it is. The storage bin 12 is typically formed of ferrous material whereby the magnets of the fill level sensor(s) affix directly thereto. If the bin 12 is formed of plastic or other non-ferrous material, the fill level sensors 52 and microphone enclosures 66 can be affixed to the bin 12 via Velcro or via use of adhesives, or other suitable fastener means. Alternatively, the fill level sensors 52 can be magnetically affixed to suitable ferrous plate adhesively affixed to the bin 12 or other suitable fastener means. Although the data shown herein has been collected from grain silos 12, the method applies equally to containers with liquid content. Each fill level sensor (52^{T}, 52^{M}, and 52^{B}) is positioned close to the ladder 34 for access and maintenance and includes a microphone 66 electrically interconnected to a common control panel 65 including readouts and function switches and an electrical power source 67 and an accessory outlet 72 by electrical conductors 69. The electrical power source 67 and accessory outlet 72 are spaced and electrically isolated from the host storage bin 12 and support system 10. As an alternative. The microphones 66 can be integrally formed with their associated fill level sensor housing 53.

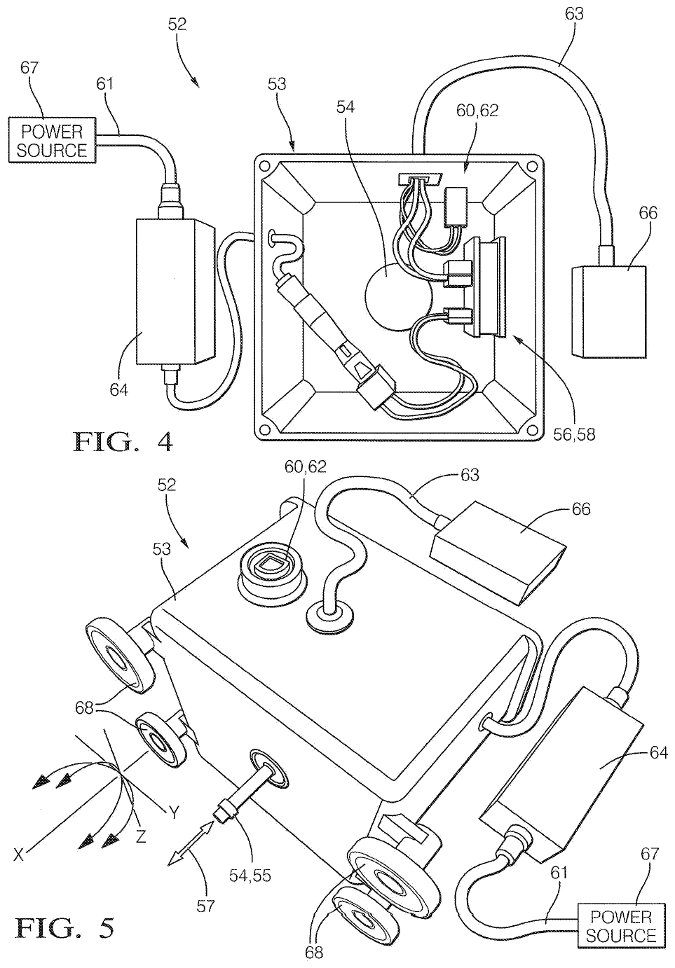

Referring to FIGS. 4-6, each fill level sensor 52 consists of a hermetically sealed plastic housing 53 enclosing a solenoid 54, a solenoid plunger 55, a microprocessor based electronic circuit 56, an SD memory card 58, a reset button 60, and a LED 62. A power supply 64 and a microphone 66 are in circuit with the level sensor 52 by interconnecting cables 61 and 63. The fill level sensors 52 are vertically separated and disposed whereby approximately ⅓ of the volume of the storage bin 12 is located between the uppermost and center fill level sensors 52, approximately ⅓ of the volume of the storage bin 12 is located between the center and lowermost fill level sensors 52, and approximately ⅓ of the volume of the storage bin 12 is located between the lowermost fill level sensor 52 and the outlet 22.

The acoustic sensors 52 of the present invention function to record the echoes generated by the solenoid plunger 55 hit or strike against the adjacent silo surface and determines the fill level based on a calibrated algorithm. The algorithm can be fixed, or varied at the will of the operator and/or in response to market and/or weather conditions. The solenoid plunger 55 moves bi-directionally as indicated by an arrow 57. The strength or magnitude of the echo grows larger as the silo empties and the algorithm adapts to each silo 12 by observing the rise and fall of the echo strengths through one or more initial refill cycles. The closest system known that is disclosed publicly is presented in a scientific paper (Garcia, Adrian et al., Non-Intrusive Tank-Filling Sensor Based on Sound Resonance, Electronics, 2018, 7, 378; doi:10.3390/electronics 7120378), whose significant difference from the invention disclosed here is that the system in the paper utilizes resonance frequencies that are present in the echo to arrive at the fill levels while in the present invention, the total power of the echo is used (which includes the entire spectrum of the echo).

Referring to FIGS. 4 through 7, the sensor 52 consists of the solenoid 54 (with plunger 55), a microprocessor/microprocessor 56, the SD (Secure Digital) memory card 58, the reset button 60, the light emitting diode or LED 62, the power supply 64 and the microphone 66. The sensor is packaged and waterproofed for long-term outdoor usage, and is placed on the outside of a silo 12 as shown in FIG. 1, and is held in place via use of magnets 68. Neither the sensor 52 nor the microphone 66 require inserting a part or device into the silo 12 and hence is non-intrusive, which is what sets it apart from all other products on the market. As best illustrated in FIG. 5, a plurality (typically 4) of permanent magnets 68 are affixed to the outer surface of the sensor 52 so as to circumscribe the solenoid plunger 55. Each magnet 68 has a circular engagement surface normal to the axis 57 of the plunger 55. The magnets 68 are each either permanently affixed to the sensor 53 as illustrated normal to outwardly extending axis “X”, or are mounted for limited gimbal or circular motion off normal axes “Y” and “Z” to accommodate for irregular or curved outer surfaces of the outer bin wall surface to maximize overall magnetic adhesion therebetween.

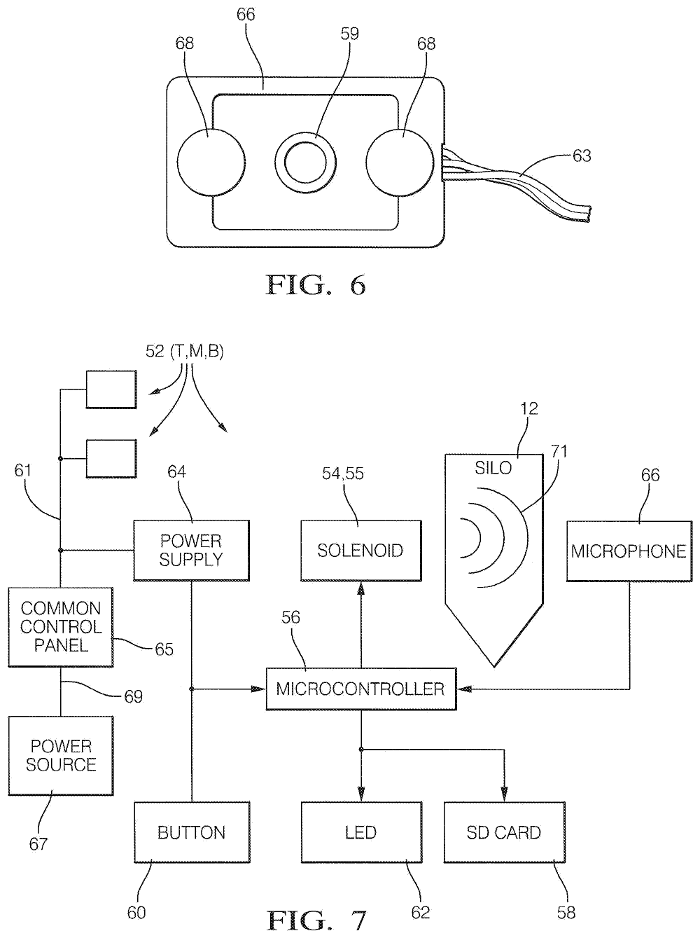

A functional block diagram of the system is illustrated in FIG. 7 including the power supply 64. FIGS. 4, 5 and 6 represent pictures of the actual sensor 52. FIG. 6 illustrates a plan view of the microphone 66 including a resilient ear piece 59 which, in application is compressively disposed between the outer surface of a silo 12 and the microphone 66 which captures and directs echo waves 71 generated by the solenoid 54/55.

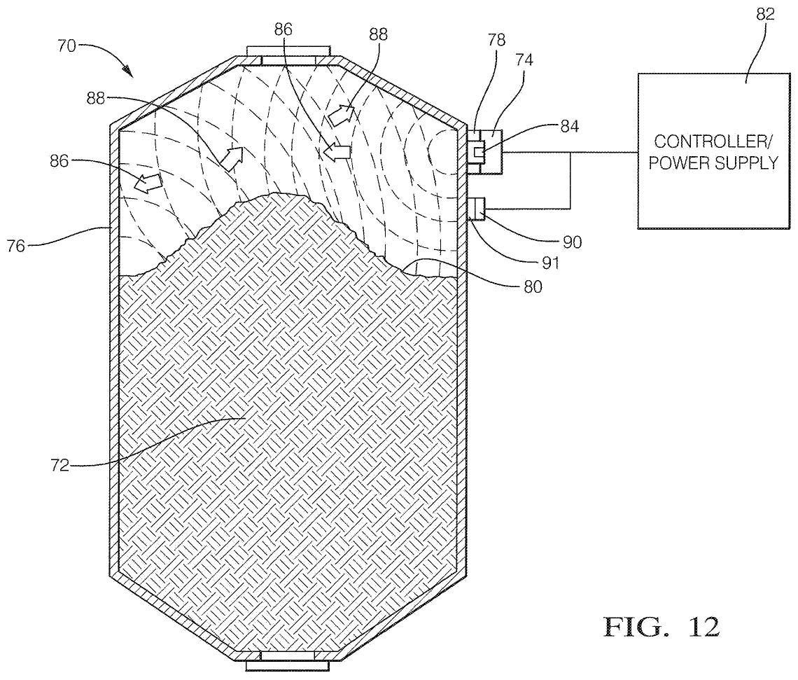

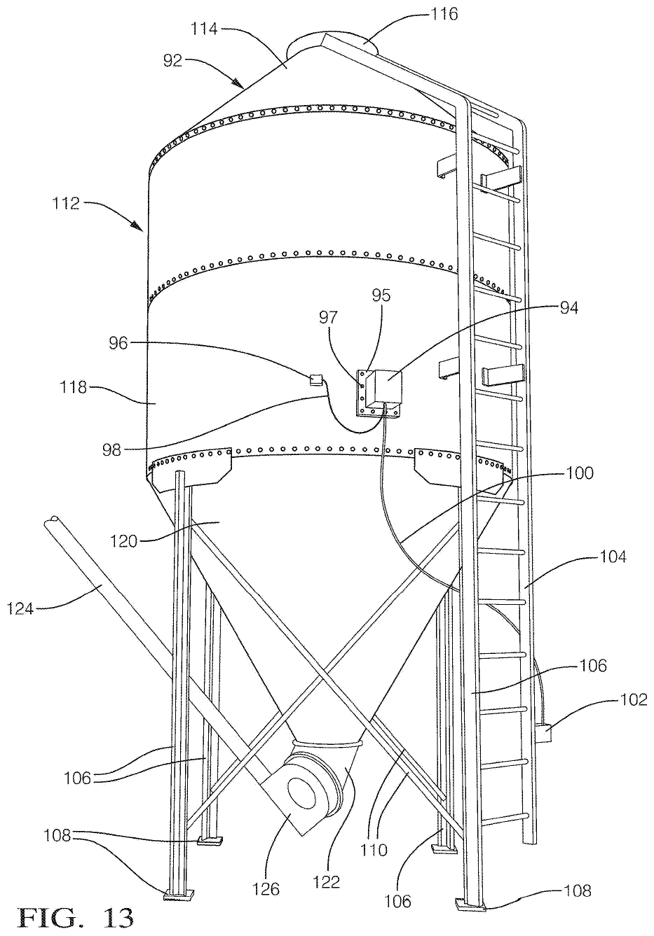

A measurement is initiated by the microcontroller 56, which activates the solenoid 54, hitting the outer surface of the silo 12 and causing an echo wave 69, as illustrated in FIG. 12. The echo wave 69 then impacts another surface of the silo 12 is then detected/picked up by the microphone 66 and recorded by the microprocessor 56, which processes the echo and determines if the silo 12 needs to be refilled. If the silo 12 has one sensor as in FIG. 13, then the microprocessor 56 on that sensor decides if the silo 12 has to be refilled, in which case the LED 62 is turned on. The echo and accompanying metadata is then saved to the SD card 58 by the microprocessor 56 for review and examination during diagnosis or regular maintenance. The button 60 is used to signal to the microprocessor 56 to recalibrate. This is done if the type of content or the refill cycle changes. In the silo 12 has more than one sensor as shown in FIG. 1, each sensor operates exactly the way a single sensor system does except no one sensor decides on the fill level on its own but rather each sensor light comes on if the fill level crosses that sensor and stays on until the silo refills. Although it is not the subject of this invention, alternatively, all three sensor readings could be pulled together on a central sensor to report on the fill level, which could be posted on a website in real time via use of a cellular modem.

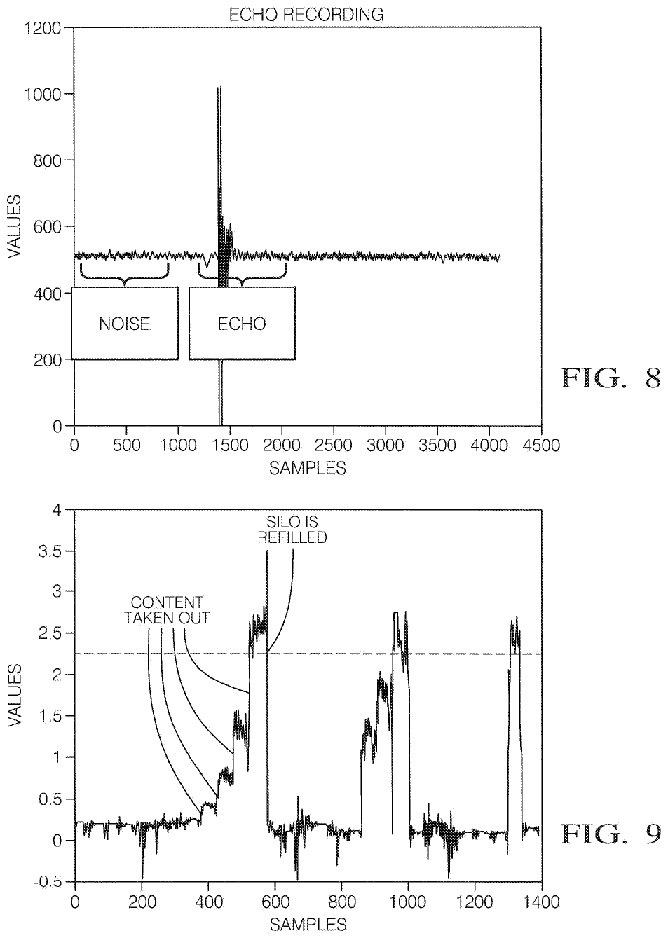

Referring to FIG. 8, the algorithm first denoises the echo, then computes the power in the echo and then uses that value to determine if the silo 12 is nearly empty and has to be refilled. Denoising the echo is accomplished by computing the frequency content in the areas of FIG. 8 labeled “noise” and “echo”, and subtracting the noise frequencies from the echo frequencies. That denoised echo is then integrated over time to obtain an estimate of the echo power (“loudness”).

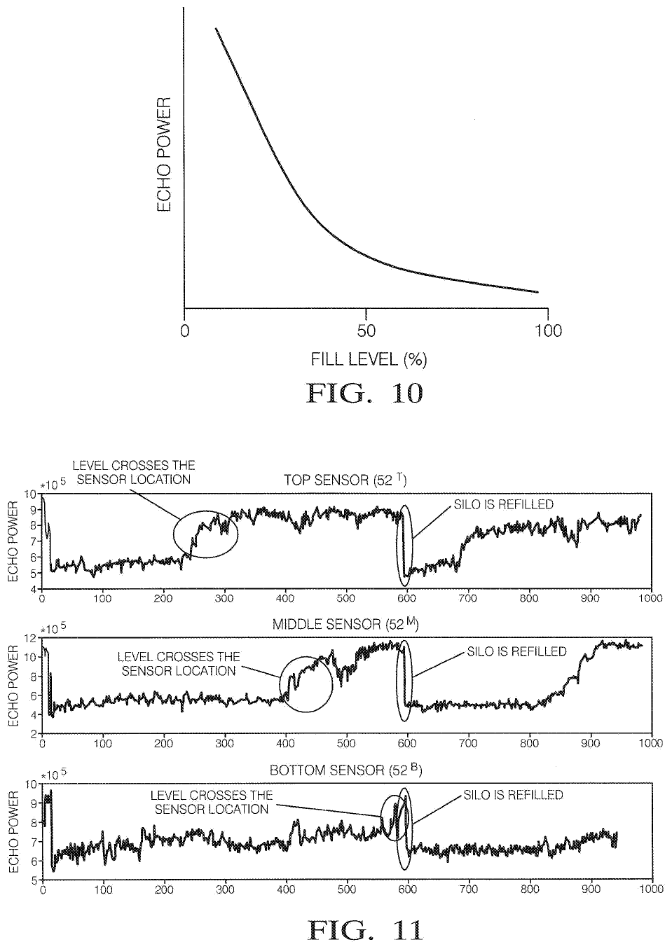

FIG. 9 depicts echo power vs. time showing emptying and filling of the silo. Restated, FIG. 9 shows many (approx. 1400) computed echo powers plotted against time with each data point representing how loud the echo is after each solenoid hit. This particular data was collected by a solenoid hit repeated five times one second apart every 30 minutes. For each point shown in the figure, the echo powers for each successive hits (one second apart) are averaged to eliminate occasional slips in solenoid hits. Comparing against actual silo fill levels shows that the increases in echo power correlate well with the fill level drop (the echo gets louder as the silo empties). Depending on the needs of the farmer and/or the type of silo, the alert functionality of the system will change because each silo 12 is different and requires individual calibration:
A. Alert when it is time to refill: If the farmer only wants to know when it is time to refill, then a simple threshold on the echo power curve as shown in FIG. 9 will do. In typical use, the farmer (or operator of the site) likes to know when the silo 12 is close to being empty. In order to signal the farmer to this event, the system first records data over a period of time, during which the silo 12 empties and refills a few times. This reveals the max and min recorded echo power and a threshold is set accordingly to alert the farmer following the calibration period.
B. Fill level monitoring (small silo): If the farmer wants to continuously monitor the fill level, then a curve has to be fit to the echo vs time curve of FIG. 9 to arrive at the curve shown in FIG. 10 by assuming a uniform speed pf drop in the fill level and averaged over few refill cycles. This has been shown to be accurate on small silos by using a single sensor installed close to the bottom of the silo (as in FIG. 13). The relationship between the echo power and the fill level is non-linear and resembles the curve depicted in FIG. 10. Small silos typically refill over a week or two so it is reasonable for the farmer to wait a few refill cycles before starting to rely on the fill levels reported by the system.
C. Fill level monitoring (large silo): Generation of a curve such as the one shown in FIG. 10 is not possible for large silos, where the height to diameter ratio is larger than 1.5 (refer FIG. 1), by use of single or multiple sensors because of the absence of the definition for a single “echo power” number (vertical axis in FIG. 10) due to localized nature of the echo power along the height of the silo. In other words, in the case of a single sensor, the curve will be too non-linear to have sufficient accuracy and, in the case of multiple sensors, there will be many of such non-linear curves (see FIG. 10) that combining them to arrive at a unified “echo power” parameter will produce too high an error. Therefore, a multiple sensor system is envisioned to be installed on large silos and only one fill cycle is needed to calibrate them. FIG. 1 shows the three sensors installed along the height of a similar large silo 12 at a current test site while FIG. 11 shows the echo power readings vs time recorded by the three sensors. The sensor location crossings are clearly identifiable during a single fill cycle and so is the time of the refill. The sensor crossings of the individual sensors are used along with the location of the sensors to predict where the fill level is. This actual particular silo is refilled every 24 days and that is the duration of the time needed for calibration.

FIG. 11 is a graphical depiction of echo power readings vs. time recorded simultaneously by the three sensors (52^{T}, 52^{M} and 52^{B}) installed on a large silo similar to that depicted in FIG. 1. By way of example, as the contents level of the fully filled storage bin 12 falls below the upper fill level sensor 52T, a near step increase in the echo magnitude is detected between the 200^{th} and 300^{th} sensor reading points. Subsequently, as the contents of the partially filled storage bin 12 falls below the middle fill level sensor 52M, a second near step increase in the echo magnitude is detected between the 400^{th} and 500^{th} sensor reading points. Finally, as the contents of the minimally filled storage bin 12 falls below the bottom fill level sensor 52B, a third near step increase in the echo magnitude is detected near the 600^{th} sensor reading point. As programmed by the silo operator, the silo bin 12 is then scheduled for refilling. After refilling at or near the 600^{th} detection cycle repeats as indicated earlier.

FIG. 12 illustrates a silo bin 70 which, by way of example, is substantially full of grain 72. The silo bin 70 includes an upper inlet and lower outlet as described elsewhere herein. A fill level sensor 74 is affixed to the outer surface of a side wall 76 of the silo bin 70 by a permanent magnet 78 at a location adjacent or above the desired maximum upper surface 80 of the grain 72. A controller/power supply 82 is wired to a solenoid 84 in the sensor 74 which, when activated, has a plunger (not illustrated) which contacts the outer surface of the side wall 76 creating impulse waves 86 which traverse the open cavity of the silo bin 70 above the upper surface 80 of the grain 72. Reflected (from exposed inner surfaces of the silo bin 70 and grain surface 80), amplified reflected waves 88 are received by a microphone 90 and are processed by the fill level sensor controller 82. The microphone 90 is preferably affixed to the side wall 76 of the silo bin 70 by a permanent magnet 91. The processed full level information is subsequently transmitted to the silo bin 70 operator. A support structure, similar to that of that depicted in FIG. 1 is deleted here for the sake of simplicity.

FIG. 13 illustrates a relatively small silo bin 92 requiring only a single fill level sensor 94 similar to that illustrated in FIGS. 4-6. The fill sensor 94 includes a microphone 96 interconnected by an electrical cable 98. A power cable 100 interconnects the fill level sensor 94 with an outside power source 102. The fill level sensor 94 and the microphone 96 are magnetically or adhesively affixed to the outer surface of the silo bin 92 and is positioned near to an access ladder 104. Alternatively, if the silo bin 92 is constructed of non-ferrous material such al aluminum, the fill level sensor 94 can be held in place via use of Velcro or, a patch 95, formed of ferrous material, can be affixed to the outer side wall 118 surface of the silo bin 92 by adhesives, fasteners 97 or the like to retain the fill level sensor 94 in its illustrated position. FIG. 13 illustrates a storage bin system 112 including the bin 92 which is supported by four legs 106, each resting on the ground on a foot member 108. Rigidity is provided by inner support members 110 which extend cross-wise between adjacent pairs of legs 106. The upper end of the bin 92 is closed by a conical roof 114, surmounted by an inlet 116 which can be opened to access the bin 92 for adding material therein and closed to block entry of moisture, debris, insects, contamination and the like. The lower end of the bin 90 is closed by a conical base member 120, which terminates at its lower end at an outlet 122 for controllably discharging the bin 92 contents to an outlet feed tube 124 through an outlet feed tube pivot/blower 126.

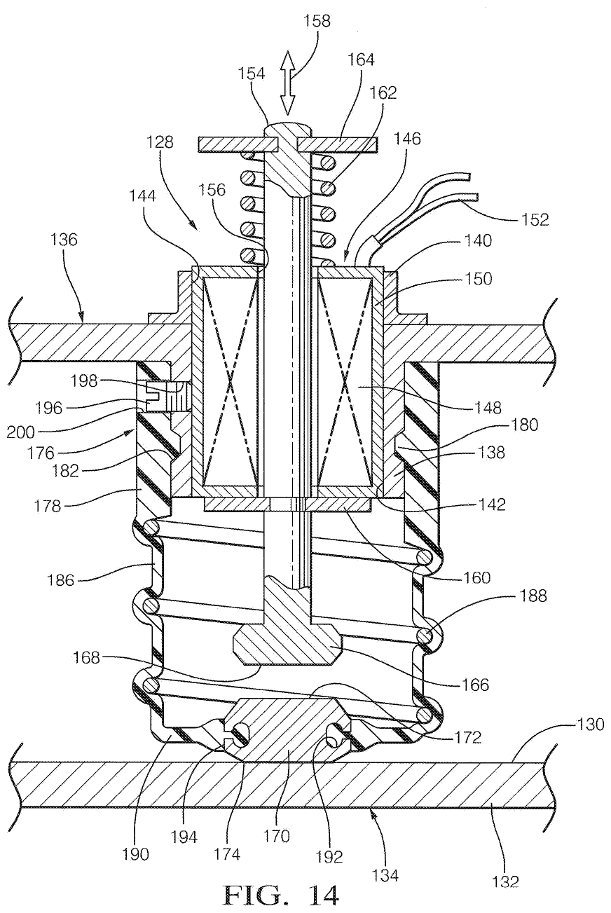

FIG. 14 is an alternative embodiment of the present invention which depicts an enlarged, broken, cross-sectional view of a fill level sensor 128 which is magnetically attached to the outer surface 130 of a side wall 132 of a storage bin 134. The fill level sensor 128 is similar to the embodiment depicted in FIGS. 4 and 5, including a hermetically sealed housing 136 which is spaced from the outer surface 130 of the side wall 132 by a plurality of magnets and stand-off structures (not shown). The housing 136 has a circular flange 138 integrally formed therein extending outwardly toward the outer surface 130 of the storage bin 134 and a separate discrete inner flange 140 extending inwardly within the housing 136.

Flanges 138 and 140 form concentric bores 142 and 144, respectively, which receive a solenoid assembly 146 extending therethrough. The solenoid assembly 146 includes an electromagnet 148 and a frame 150 formed of ferro-magnetic material slip-fit within concentric bores 142 and 144 and electrical feed lines 152 connected to an electronic circuit (not shown) within the housing 136. A magnetic plunger 154 is slip-fit in a through passage 156 formed in the electromagnet 148 for limited linear bi-directional displacement as depicted by two-headed arrow 158. Upward displacement of the plunger 154 is limited by a lower member 160 carried for displacement with the plunger 154. A compression spring 162 is disposed concentrically on the plunger 154 and extends between the upper surface of the frame 150 and the lower surface of an upper stop member 164. The compression spring 162 continuously urges the plunger 154 toward its upward limit of travel as illustrated in FIG. 14. The compression spring 162 and upper stop member 164 both have a maximum outer diameter which are less than the inner diameters of bores 142 and 144, enabling selective adjustment as well as removal of the entire solenoid assembly 146 from the fill level sensor 128 for calibration and servicing. In operation, the solenoid assembly 146 is axially fixed in its illustrated operating position by a set screw 196 disposed within a threaded radial bore 198 formed within circular flange 138 and fixedly engaging the outer surface of the solenoid frame 150. A radial opening 200 is formed in the base portion 178 of sealing member 176 to provide access to the set screw 196.

The lower end of the plunger 154 forms an enlarged hammer 166 having a relatively flat striking surface 168 which, in the deenergized condition, is spaced from the outer surface 130 of the side wall 132 of the storage bin 134. An anvil 170, preferably formed of similar material as that of the side wall 132 of the storage bin 134, is located between the striking surface 168 of the hammer 166 and the outer surface 130 of the side wall 132 of the storage bin 134. As illustrated, the upper contact surface 172 of the anvil 170 registers with the striking surface 168 of the hammer 166. The opposite, lower surface 174 of the anvil 170 is positioned to continuously engage the adjacent outer surface 130 of the side wall 132 of the host storage bin 134.

The mass of the hammer 166 and the surface area of the striking surface 168 are substantially similar to the mass of the anvil 170 and surface area of the striking surface 172 as well as the lower contact surface 174, whereby impact forces resulting from the hammer 166 striking the anvil 170 and, in turn the side wall 132 of the storage bin 134 are consistent from strike to strike, and over extended periods of time. The hammer 168 and the anvil 170 are preferable formed of similar material with similar surface and compressive characteristics.

A generally cup-shaped sealing member 176 fully encloses the portion of the solenoid assembly 146 extending externally of the housing 136 through bores 142 and 144. The sealing member 176 is preferably formed of rubber or other suitable non-porous material which is relatively flexible and affords an air-tight closure of the hermetically sealed housing 136. The upper, base portion 178 of the sealing member 176 is relatively thick and rigid and includes an inwardly extending annular flange 180 which lockingly engages a mating outwardly opening annular recess 182 formed on the outer surface of the circular flange 138. A compressive fitting such as a hose clamp (not illustrated) can enhance sealing engagement of the sealing member 176 to the mating flange 138. A lower cup-like portion 184 of sealing member 176 is integrally formed with the upper base portion 178 and has a relative thin axially flexible side wall 186. A spring 188 or another suitable stiffening member is insert molded within the cup-like portion 184 to provide axial flexibility but to maintain radial stiffness. The lower cup-like portion 184 of sealing member 176 includes a bottom portion 190 integrally formed with the side wall 186. The center of the bottom portion 190 of the sealing member 176 is insert-molded within a circumferentially outwardly opening recess 192 formed in the outer peripheral wall 194 of the anvil 170. As described, the sealing member 176 maintains the hermetic integrity of the housing 136 while permitting direct (ex. metal to metal) contact between the hammer 166, the anvil 170 and the side wall 132 of the storage bin 134, providing sharp, crisp acoustic impulses. The cup-like portion 184 of the sealing member 176 serves to retain the anvil 170 in intimate, constant biasing pressure against the side wall 132 of the storage bin 134, to maintain the hammer 166 in precise axial alignment with the anvil 170, and to allow a degree of float, or relative axial displacement between the hammer 166 and the anvil 170, such as due to mechanical wear, ambient temperature, atmospheric pressure, and the like.

A significant advantage of the fill level sensor 128 described in FIG. 14, is that it can be serviced, such as for removal and replacement of a defective solenoid assembly 146 without removal of the fill level sensor 128 from a host storage bin 13. Furthermore, a compressible sealing member similar to that described as 176 in FIG. 14 can be employed with a microphone 66 as described in FIG. 6 wherein the microphone “ear piece” 59 can extend from the microphone housing to the adjacent outer surface of the storage bin 134 to focus echo sound waves within the “ear piece” and acoustically isolate them from extraneous external noise sources. Furthermore, the sealing member 176 can be adjusted to selectively vary the pressure of urging the anvil 170 against the outer surface 130 of the side wall 312 of the host storage bin 134 as a function of varying bin 134 wall characteristics and/or varying weight/density of material stored within the bin.

In FIG. 14, the hammer 166 is illustrated as being, integrally formed with the plunger 154. Alternatively, the hammer can be made adjustable/removable with respect to the plunger as illustrated in FIG. 5. This advantage allows for replacement with a larger/smaller hammer as the result of damage/wear, or the need for a lighter/heavier hammer or a hammer formed of different material to accommodate varying material characteristic of the adjacent side wall 132 of a host storage bin 134.

Although the present invention includes one or more fill level sensors which are magnetically attached to the outer side wall of a host storage bin, it could be semi-permanently attached such as by adhesives, weldments, or vacuum fixtures.

The present invention is intended to save time and money spent otherwise in determining the silo fill levels, hopefully reduces farm related injuries and deaths, and streamlines the farm operations, especially in establishments with a large number of silos.

Though the data shown herein has been collected from grain silos, the method/apparatus applies equally to containers with liquid content.

The following documents are deemed to provide a fuller background disclosure of the inventions described herein and the manner of making and using same. Accordingly, each of the below-listed documents are hereby incorporated into the specification hereof by reference.
U.S. Pat. No. 3,061,063 to Rutten entitled “Silo Chute Hopper”.
U.S. Pat. No. 4,963,066 to Boppart entitled “Grain Hopper Assembly”.
U.S. Pat. No. 4,989,380 to Krauss entitled “Silo for Pulverulent and Fine-Grained Bulk Materials”.
U.S. Pat. No. 5,108,010 to Murray entitled “Storage Silo with Improved Material Flow”.
U.S. Pat. No. 6,330,767 B1 to Can et al. entitled “Unloading System for Particulate Materials Bins”.
U.S. Pat. No. 6,971,495 B2 to Hedrick et al. entitled “Mass Flow Hopper and Method of Manufacture”.
U.S. Pat. No. 7,513,280 B2 to Brashears et al. entitled “Apparatus and Methods for Discharging Particulate Material from Storage Silos”.
U.S. Pat. No. 8,245,735 B2 to Chase et al. entitled “Select Fill Sensor for Refrigerator Dispensers”.
U.S. Pat. No. 8,312,818 B2 to Poncet entitled “Modular Vibratory Floor”.
U.S. Patent Application No. 2020/0041324 A1 to Dieterle entitled “Radar Sensor for Fill Level or Point Level Measurement”.
U.S. Pat. No. 8,434,278 B1 to Dueck et al. entitled “Storage Bin Support System”.
U.S. Pat. No. 8,584,905 B2 to Thiessen entitled “Hopper Bottom for Storage Bin” to Theissen entitled “Hopper Bottom for Storage Bin”.
U.S. Patent Application No. 2014/0000189 A1 to Grossman et al. entitled “Granular Material Storage Container and Associated Method”.
U.S. Pat. No. 8,668,424 B2 to Niemeyer et al. entitled “Circular Bin Unload System and Method”.
U.S. Pat. No. 8,677,705 B2 to Dyson entitled “Grain Bin Support Structure for Conditioning System and Method of Installing Same”.
U.S. Patent Application No. 2015/0050724 A1 to Lesperance et al. entitled “Silage Waste Recovery Process, Facility, System, and Product.
U.S. Pat. No. 9,170,148 B2 to Bayley et al. entitled “Soap Dispenser Having Fluid Level Sensor”.
U.S. Patent Application 2020/0041324 to Dieterle entitled “Radar Sensor for Fill Level or Point Level Measurement”.
Garcia, Adrian et al., Non-Intrusive Tank-Filling Sensor Based on Sound Resonance, Electronics, 2018, 7, 378; doi:10.3390/electronics 7120378.

It is to be understood that the invention has been described with reference to specific embodiments and variations to provide the features and advantages previously described and that the embodiments are susceptible of modification as will be apparent to those skilled in the art.

Furthermore, it is contemplated that many, alternative, common inexpensive materials can be employed to construct the basic constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

1. An acoustic sensor operative to record echoes generated by a solenoid plunger strike on an external storage silo surface and determine the silo fill level based upon a calibrated algorithm which calculates the total power of the echo and adopts to a given silo as a function of the rise and fall of the calculated echo strength through a plurality of initial silo refill cycles.

2. The acoustic sensor of claim 1, comprising circuit elements including a microcontroller, an SD card, a reset button, a read-out device, and a power supply.

3. The acoustic sensor of claim 2, wherein said read-out device comprises at least one LED integrated within said reset button.

4. The acoustic sensor of claim 1, further comprising a hermetically sealed housing enclosing said circuit elements.

5. The acoustic sensor of claim 4, further comprising at least one permanent magnet operative to affix said housing to a predetermined external position on said external silo surface.

6. The acoustic sensor of claim 4, further comprising a plurality of permanent magnets arranged in an array about said solenoid plunger.

7. The acoustic sensor of claim 6, wherein said plurality of permanent magnets comprise two spaced apart magnets aligned with said solenoid plunger.

8. The acoustic sensor of claim 6, wherein said plurality of permanent magnets comprise at least three circularly arranged spaced apart magnets concentrically aligned with said solenoid plunger.

9. The acoustic sensor of claim 1, further comprising a microphone in circuit with said circuit elements and hermetically sealed within a second housing which is magnetically affixed to the exterior surface of said silo at a location distal said first housing.

10. The acoustic sensor of claim 9, wherein said silo is substantially cylindrical in shape and said solenoid plunger and said microphone are circumferentially spaced from one another along the outer parameter of said silo.

11. An apparatus operative to monitor the fill level of fungible material in a storage silo, said apparatus comprising:
an electronic controller circuit including a logic circuit;
a solenoid assembly including an electromagnet fixedly attached to an external wall of said storage silo and a plunger which is linearly displaceable in response to electrical energization of said electromagnet by said control circuit between a first position spaced from said silo wall and a second position contacting said silo wall to affect an impact noise; and
a microphone assembly fixedly attached to said storage silo wall distal from said solenoid and operative to detect each time the plunger contacts said silo wall.

12. The apparatus of claim 11, wherein said electronic controller circuit further comprises a memory circuit operative to record an event corresponding with each said plunger strike, and the time between successive plunger strikes.

13. The apparatus of claim 12, wherein said electronic controller circuit is operative to detect when said silo is partially or fully refilled with said fungible material.

14. The apparatus of claim 13, wherein said electronic controller circuit includes a logic circuit operative to independently calculate redundant warning signals when said silo is partially or fully refilled with said fungible material.

15. The apparatus of claim 14, wherein said electronic controller circuit is operative to broadcast the first in time warning signal when said silo is partially or fully refilled with said fungible material.

16. The apparatus of claim 13, wherein said electronic controller circuit includes a date stamp device operative to chronologically record each time said silo is partially or fully refilled with said fungible material.

17. A method of continuously monitoring the fill level of fungible material in a vertically elongated storage silo comprising the steps of:
mounting at least one sensor to the outer surface of said silo, said sensor including a solenoid assembly including an electromagnet fixedly attached to the silo and a plunger displaceable between a first position spaced from said silo and a second position striking said silo;
periodically actuating said solenoid;
measuring the strength of a pressure pulse or echo resulting from each said strike; and
periodically calculating the fill level of said storage silo.

18. The method of claim 17, further comprising the step of tracking the rise and fall of the echo power and relating it to fill level using either one or more sensors recognizing that the echo power increases monotonically as the silo empties (or as the fill level drops).

19. The method of claim 17, further comprising the step of generating a warning signal when the fill level of said storage silo falls to a predetermined level.

20. The method of claim 17, further comprising the step of generating a broadcast signal containing the estimate of the fill level in percentage or in height from the bottom of the silo.

21. The method of claim 17, further comprising the step of denoising each echo to mitigate ambient noise.

22. The method of claim 17 further comprising means to broadcast an action required signal to a remote operator when the fill level of said storage silo falls to a predetermined level.

23. The acoustic sensor of claim 6, wherein at least one of said plurality of permanent magnets is interconnected to said housing via a gimbal mechanism enabling relative rotation along two normal axes to enable planar engagement with each magnet to an adjacent surface of said external silo surface.

24. The acoustic sensor of claim 1, wherein said microphone in circuit with said circuit elements is hermetically sealed within said housing which is magnetically affixed to the exterior surface of said silo at a location distal said first housing.
